(19) United States
(12) Patent Application Publication
(10) Pub. No.: US 2013/0097233 A1
(43) Pub. Date: Apr. 18, 2013

(54) USING DEVICES TO LINK SOCIAL NETWORK PROFILES

(71) Applicants: Sunder N. Raman, Redmond, WA (US); Rajesh Ramanathan, Seattle, WA (US); Ronald P. Di Sandro, Seattle, WA (US)

(72) Inventors: Sunder N. Raman, Redmond, WA (US); Rajesh Ramanathan, Seattle, WA (US); Ronald P. Di Sandro, Seattle, WA (US)

(73) Assignee: MICROSOFT CORPORATION, Redmond, WA (US)

(21) Appl. No.: 13/272,319

(22) Filed: Oct. 13, 2011

(51) Int. Cl. G06F 15/16

(52) U.S. Cl. 709/204

(57) ABSTRACT

A token authorizing linking to a first social network profile can be received from a first device at a second device. User input can be received at the second device to authorize linking the first social network profile with a second social network profile. In response to the user input, a social network service can be requested to link the first social network profile to the second social network profile on the social network. Also, a token request associated with a first social network profile can be received at a social network service. In response, a first token can be returned. A second token associated with a second profile can also be received. In response, it can be determined whether the second token is a valid match for the first token, and if so, then the first profile can be linked to the second profile on the social network.

### BACKGROUND

Contact information has been exchanged in printed form, such as by exchanging printed business cards. When such contact information changes, the information can be re-printed and distributed to contacts manually. Receivers of the printed information can then update their address books. An alternative to this information exchange includes sending digital contact information, such as by emailing the contact information. When such contact information is to be updated, computer users can email the updated contact information.

Information can also be shared via social networks. Social networks are networks of linked profiles, where linking of profiles can allow users of those profiles to access each others' profile information. The profile information may include various different types of information, such as contact information, information on personal interests, photographs, business or professional information, schedules of activities, etc.

### SUMMARY

The tools and techniques discussed herein relate to using devices, such as handheld computing devices, to link social network profiles. This can include sending one or more tokens between devices, and it may also include requesting that one or more social network services link one or more social network profiles on one or more social networks. In so doing, the tools and techniques may provide one or more benefits such as reducing the number of steps that users take to build a relationship between their social networks. As used herein, a token is an item of digital information that represents an authorization to link one or more social profiles on a social network. For example, a token may represent an authorization to link to one profile, and additional authorization may be received for linking to another profile so that the two profiles can be linked together in a social network. A token may take any of various forms, such as a globally unique identifier, a public key or signature, etc.

In one embodiment, the tools and techniques can include receiving a token sent from a first device to a second device. The token can include information authorizing linking to a first social network profile. User input can be received at the second device to authorize linking the first social network profile with a second social network profile on a social network. In response to the user input, a social network service can be requested to link the first social network profile to the second social network profile on the social network.

In another embodiment of the tools and techniques, a token request can be received at a social network service that manages a social network. The token request can be associated with a first profile on the social network. In response to the token request, a first token can be returned. A second token associated with a second profile on the social network can also be received. In response to receiving the second token, it can be determined whether the second token is a valid match for the first token, and if so, then the first profile can be linked to the second profile on the social network.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described embodiments may be implemented.

FIG. 2 is a schematic diagram of a social network profile linking environment.

FIG. 3 is an illustration of a sending device.

FIG. 4 is an illustration of the sending device of FIG. 3 displaying a tag, which is illustrated in schematic form without illustrating a specific tag pattern.

FIG. 5 is an illustration of a receiving device.

FIG. 6 is an illustration of the receiving device of FIG. 5 displaying a confirmation that user profiles have been successfully linked on social networks.

FIG. 7 is a flowchart of a technique for using devices to link social network profiles.

FIG. 8 is a flowchart of another technique for using devices to link social network profiles.

FIG. 9 is a flowchart of yet another technique for using devices to link social network profiles.

### DETAILED DESCRIPTION

Embodiments described herein are directed to techniques and tools for improved linking of profiles on social networks. Such improvements may result from the use of various techniques and tools separately or in combination.

Such techniques and tools may include allowing a user to use a device such as a smart phone to share information with another device and to add to the user's social network(s). For example, such social networks could include personal social networks (e.g. the Facebook® social network), professional social networks (e.g., the LinkedIn® social network), and/or corporate social networks (e.g., social networks using the MySite feature with the SharePoint® platform). The information may be shared between devices, and this sharing can lead to social network profiles for the users being linked on one or more social networks. The information may be shared between devices in any of various ways. For example, the information may be embedded in a tag that is displayed by one device and scanned by the other device. A tag is a graphical pattern that encodes information. The tag can be scanned, and the scan can be used to decode the encoded information. As another alternative, the information may be sent in a signal such as a wired or wireless signal (one example may be a signal using near field communications (NFC)).

The information may include information such as address(es) for social network service(s), a token for authorizing a social network connection, and/or other information. For example, the information may include a uniform resource locator (URL) and a token embedded in the tag. In one example, the token may authorize a single social network link, and the token may be valid for a specified period of time. Accordingly, the token may have an expiration time, such as two minutes from the time the token was generated.

The communication of the token and other information can allow the receiving device to automatically gain approval for a social network link by a service without further need for acknowledgement from users of the devices. However, some additional approval may be utilized, such as receiving authorization from user input at the receiving device. This and/or other benefits may be derived from the separate or combined use of tools and techniques described herein. The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

Techniques described herein may be used with one or more of the systems described herein and/or with one or more other systems. For example, the various procedures described herein may be implemented with hardware or software, or a combination of both. For example, dedicated hardware implementations, such as application specific integrated circuits, programmable logic arrays and other hardware devices, can be constructed to implement at least a portion of one or more of the techniques described herein. Applications that may include the apparatus and systems of various embodiments can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

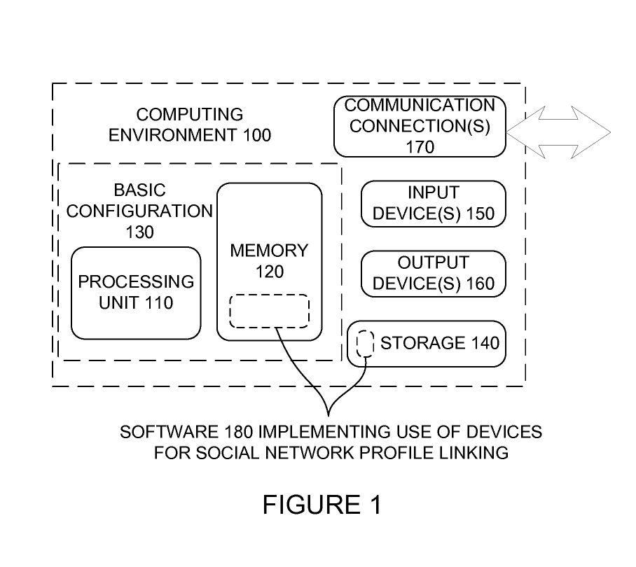

FIG. 1 illustrates a generalized example of a suitable computing environment (100) in which one or more of the described embodiments may be implemented. For example, one or more such computing environments can be used as a sending device, receiving device, or a social network service. A social network service includes physical computing resources, which may include one or more machines dedicated to the service, or some resources from one or more machines dedicated to the service. Generally, various different general purpose or special purpose computing system configurations can be used. Examples of well-known computing system configurations that may be suitable for use with the tools and techniques described herein include, but are not limited to, server farms and server clusters, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse general-purpose or special-purpose computing environments.

With reference to FIG. 1, the computing environment (100) includes at least one processing unit (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing the use of devices to link social network profiles.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The storage (140) may be removable or non-removable, and may include computer-readable storage media such as magnetic disks, magnetic tapes or cassettes, CD-ROMs, CD-RWs, DVDs, or any other medium which can be used to store information and which can be accessed within the computing environment (100). The storage (140) stores instructions for the software (180).

The input device(s) (150) may be a touch input device such as a keyboard, mouse, pen, or trackball; a voice input device; a scanning device (e.g., a camera); a network adapter; a CD/DVD reader; or another device that provides input to the computing environment (100). The output device(s) (160) may be a display, printer, speaker, CD/DVD-writer, network adapter, or another device that provides output from the computing environment (100).

The communication connection(s) (170) enable communication over a communication medium to another computing entity. Thus, the computing environment (100) may operate in a networked environment using logical connections to one or more remote computing devices, such as a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. In a distributed computing environment, program modules may be located in both local and remote computer storage media.

For the sake of presentation, the detailed description uses terms like “determine,” “send,” “receive,” and “linking” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Social Network Profile Linking System and Environment

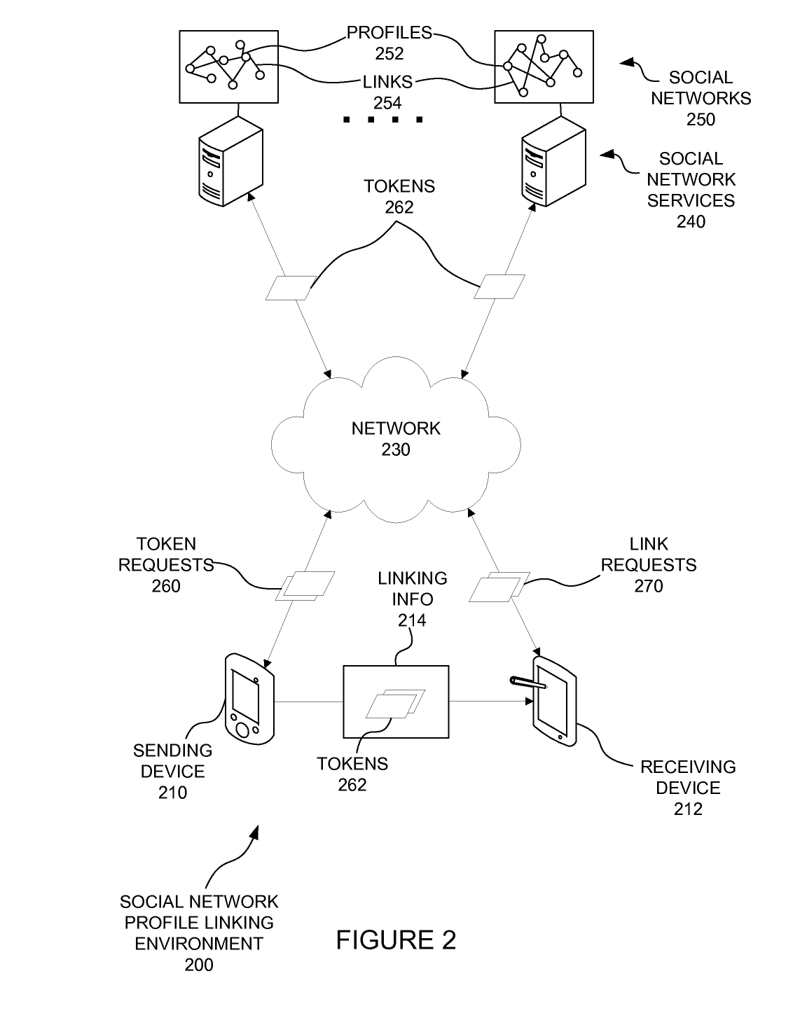

FIG. 2 is a schematic diagram of a social network profile linking environment (200) in conjunction with which one or more of the described embodiments may be implemented. The environment (200) can include a sending device (210) and a receiving device (212). The sending device (210) can communicate linking information (214) to the receiving device (212). This communication of linking information (214) may be done without involving social network services that are remote from the devices (210 and 212) in the communication, and the communication may be done without using a computer network between the devices (210 and 212). The sending device (210) and/or the receiving device (212) can also communicate over a computer network (230) with one or more social network services (240). Each of the social network services (240) can manage a social network (250), with each social network including profiles (252) that are linked together with social network links (254), which could be represented and stored in any of various forms (database records, fields in database records, etc.). For example, the social network links (254) may be referred to as representing relationships between profiles (252) or users of the profiles, such as representing the profiles (252) or users being “friends”, “contacts”, etc. The sending device (210) and the receiving device (212) can communicate with each other and with the social network services (240) to instruct and authorize the social network services (240) to link together profiles (252) on the social networks (250).

In one implementation, a sending device (210) may send one or more token requests (260) to one or more social network services (240). For example, this may be done in response to receiving user input at the sending device (210). In response to receiving a token request (260), each social network service (240) to which a request (260) was sent can generate and return a token (262) to the sending device (210). For example, in one implementation a social network (250) can use a randomization technique to generate an identifier, such as a globally unique identifier (that may be unique only at that time for that social network (250)) that can serve as the token (262). Such randomization need not be completely random, but can include at least some randomization component in the technique. For example, the resulting “random” number may actually be a pseudo random number. The social network (250) can make a record for each token (262) that is generated and returned. Each token (262) may only be valid for a set period of time. For example, a social network (250) may have each of its tokens (262) expire after two minutes from the time the token (262) was generated.

The sending device (210) can receive back tokens (262) from the social network services (240) to which token requests (260) were sent. The tokens (262) can be communicated to the receiving device (212) as part of the linking information (214). The linking information (214) may also include other information, such as information that will trigger an application on the receiving device (212) to be launched. For example, such an application may be configured to communicate with a particular social network service (240). The linking information (214) may include an address for each social network service (240) for which a token (262) is included. As an example, the linking information (214) may be a uniform resource locator that includes an address for the social network service (240) and a token (262) for that social network service (240) following the address.

For each token (262) that is received, the receiving device (212) can send a link request (270) to the social network service (240), requesting that the social network service (240) link a social network profile (252) associated with the sending device (210) to a social network profile (252) associated with the receiving device (212) on a social network (250) managed by the social network service (240). This linking may be done automatically, possibly after receiving user input to confirm that the linking of profiles (252) is approved by a user of the receiving device (212). For example, the user input to the receiving device (212) may be a single user input action, or a pair of user input actions (such as one input action to approve receiving the linking information (214) and another input action to approve sending the link request(s) (270)). The social network profile (252) may be associated with the sending device (210) in one or more of various ways. For example, the social network profile (252) could be associated with software on the device (210) (e.g., a social networking app). As another example, the social network profile (252) could be associated with the device (210) by being associated with a remote service with which the device (210) is able to communicate.

Each link request (270) can include a token (262) that was received for a social network service (240) to which the link request (270) is sent. The receiving device (212) can use the address information or other contact information for the social network service (240) that was received from the sending device (210) to direct the link request (270) to the appropriate social network service (240). The receiving device (212) can also send to the social network service (240) identifying information (e.g., login information) for a profile (252) associated with the receiving device (212). The identifying information for the profile (252) of the receiving device (212) may be sent in the link request (270), or the identifying information may be sent separately. For example, the receiving device (212) may have already sent login information to the social network service to log into the social network (250). In that situation, the link request (270) may be sent on an active channel with the social network service (240), without providing the login information again.

Upon receiving the link request (270) from the receiving device (212), the social network service can determine whether the link request is valid. For example, if the link request (270) includes a token (262), the social network service (240) can check its token records to determine whether the token (262) received from the receiving device (212) is valid. In one example, this can include checking whether the received token (262) matches a token (262) previously sent out by the social network service (240). In one technique, a token (262) may match if the token is the same as a token previously sent by the social network service (240). Alternatively, received tokens (262) may be matched to sent tokens in some other way. For example, the sending device (210) and/or the receiving device (212) may process tokens according to some technique. Accordingly, the social network service (240) may receive the token (262) in a processed form, and determine whether the processed token (262) originated from a token (262) originally sent from the social network service (240). As used herein, such a processed token (262) is not considered to be a separate token from the original token (262) so long as it can be determined whether the processed token originated from the un-processed token (262).

If the tokens (262) match, the social network service (240) can identify the profiles (252) on the managed social network (250) that are to be linked. For example, the social network service (240) can identify the profile (252) associated with the sending device (210) using the stored token record, which can list a representation of an associated profile (252). Additionally, the social network service (240) can identify the profile (252) associated with the receiving device (212) using the identifying information sent from the receiving device (212).

If the tokens (262) match, the social network service (240) can also check whether the matched token (262) has expired, or whether it is still valid. If the token is still valid, the social network service (240) can link the social network profile (252) associated with the sending device (210) to the social network profile (252) associated with the receiving device (212) on the social network (250) managed by the social network service (240).

The checking of the validity of the tokens (262), matching the tokens (262), and linking the associated profiles (252) can be done by each of the social network services (240) that receive a link request (270) from the receiving device (212). The social network services (240) may also send confirmations of the linking of profiles (252) to the sending device (210) and the receiving device (212).

Alternative techniques may be used. For example, the sending device (210) may generate the token (262) itself (rather than receiving the token from the social network service (240)), and the sending device (210) can send the token to the social network service (240) and to the receiving device (212). The receiving device (212) can forward the token on to the social network service (240), which can determine whether the token (262) from the sending device (210) and from the receiving device (212) match, and whether the token (262) is valid.

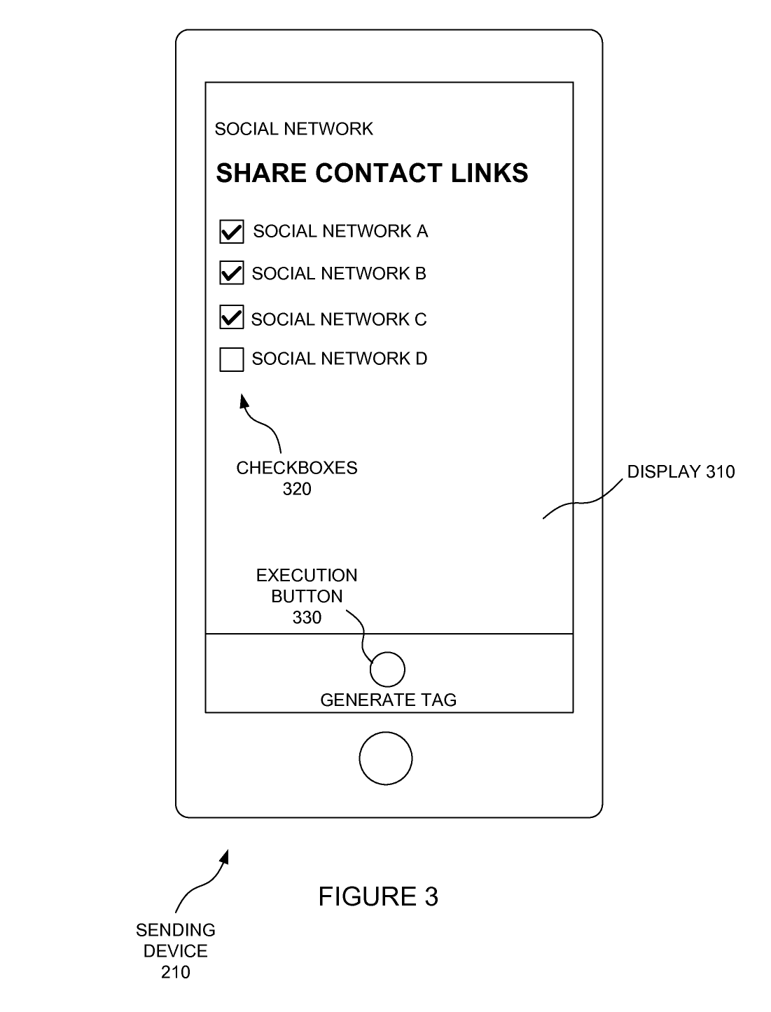

A user interface implementation example for sharing linking information using tags will now be discussed with reference to FIGS. 3-6. Referring to FIG. 3, an example of user interface features for the sending device (210) is illustrated. In one example, the sending device (210) may be a mobile handheld device, such as a smart phone. The sending device (210) can include a display (310), such as a touch screen. The display (310) can show some possible social networks for which links can be established. In the example illustrated in FIG. 3, those social networks are “SOCIAL NETWORK A,” “SOCIAL NETWORK B,” “SOCIAL NETWORK C,” and “SOCIAL NETWORK D.” The user interface can allow desired social networks to be selected. For example, the display (310) can include a checkbox (320) for each displayed social network. In the illustrated example, user input has been provided to select “SOCIAL NETWORK A,” “SOCIAL NETWORK B,” and “SOCIAL NETWORK C.” The sending device (210) may make default selections that can be changed in response to user input (e.g., touch screen input to the display (310)). For example, all the social networks for which profile information is registered on the sending device (210) may be selected by default (such as where a user already configured default sharing preferences, or where the default is derived from options that a user previously selected for sharing information with another device).

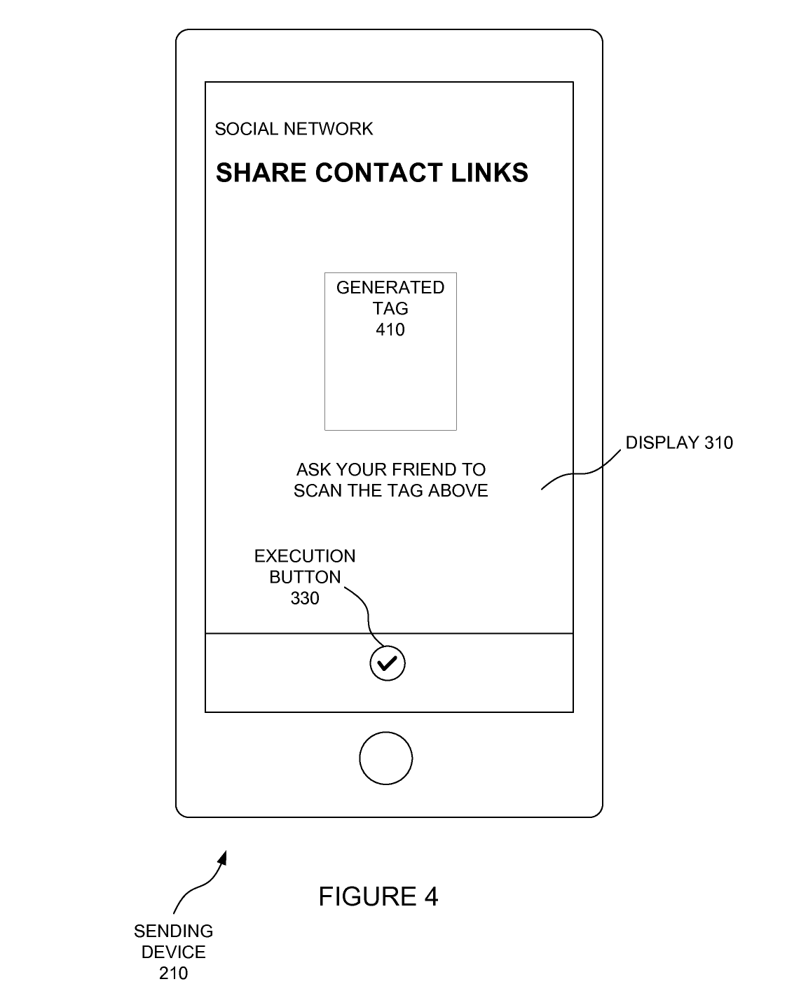

Once desired selections have been made, user input can be provided to request that the linking information be sent to another device. For example, this may be done by a user input action selecting the execute button (330), which may be a displayed button image on the display (310). Referring now to FIG. 4, in response, the sending device (210) can obtain a token for each selected social network and can generate and display a tag (410) that encodes the tokens and other information (e.g., social network service addresses, etc.) for making links on the social networks.

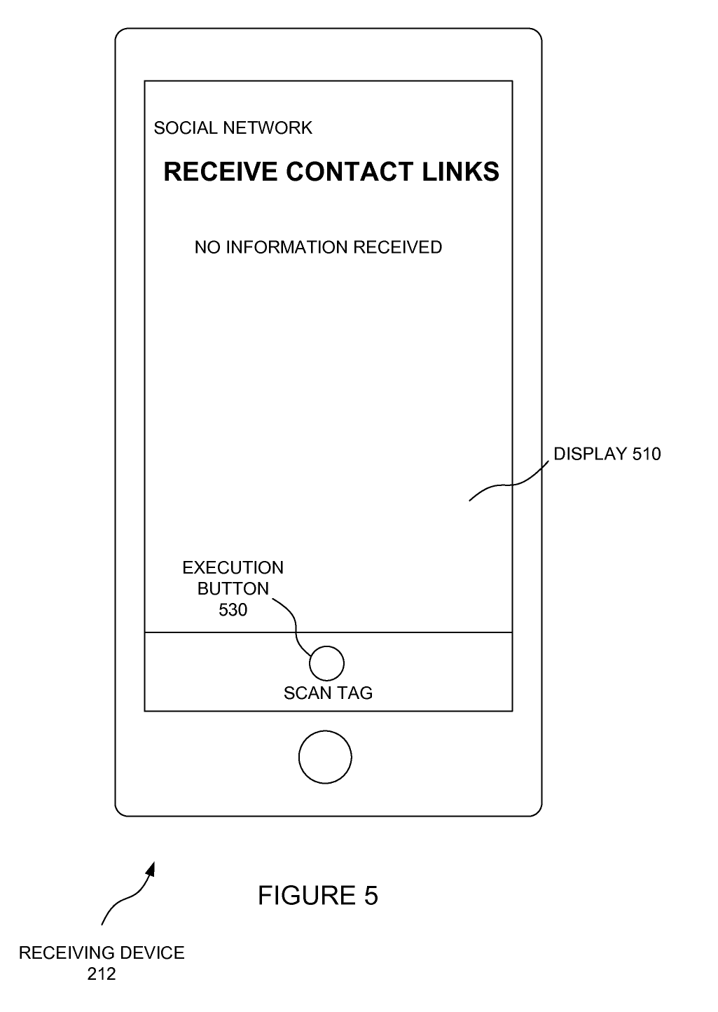

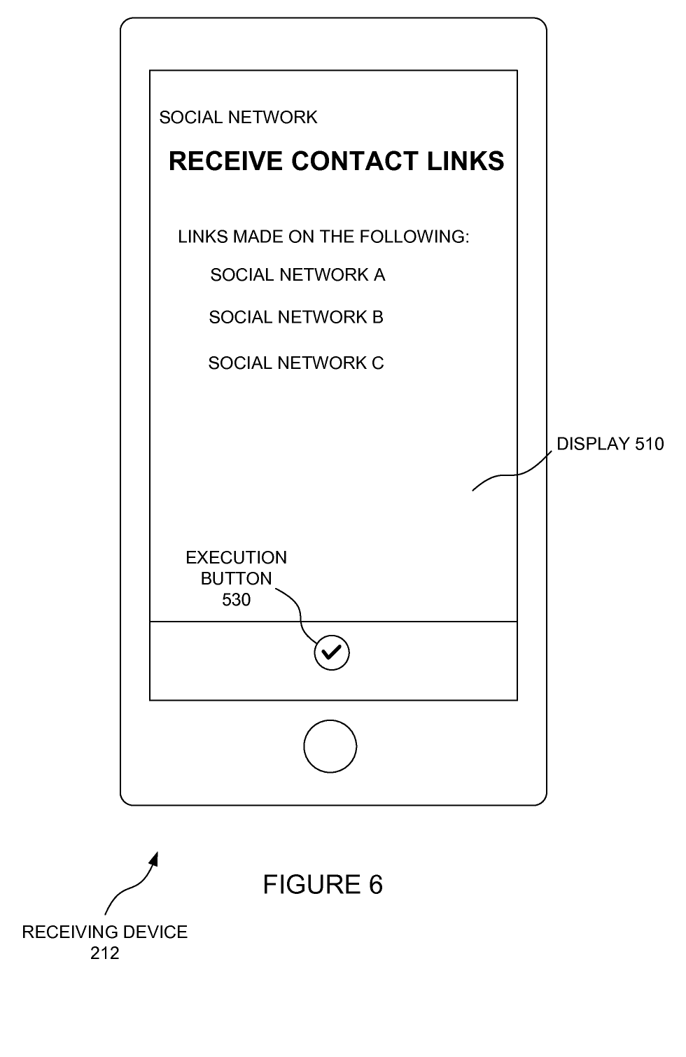

Referring now to FIG. 5, an example of a receiving device (212) is illustrated. The receiving device (212) may be a type of device similar to the sending device (210) discussed above. The receiving device (212) can include a display (510), which can display status information for the making links to profiles. An execute button (530) can be selected to scan the tag (410) with the receiving device (212) (see FIG. 4). For example, selecting the execute button (530) may allow the tag (410) to be scanned using a camera (not shown) in the receiving device (212). The receiving device (212) can decode the scanned-in image to obtain the linking information encoded in the tag (410). The receiving device (212) can then use that linking information to request that profiles associated with the receiving device (212) be linked to profiles associated with the sending device (210) on the selected social networks, as discussed above. Referring now to FIG. 6, after the receiving device (212) receives confirmation from the social network services that links have been made on the corresponding social networks, the receiving device (212) can display a confirmation. For example, as shown in FIG. 6, the display (510) may read, “LINKS HAVE BEEN MADE ON THE FOLLOWING: SOCIAL NETWORK A, SOCIAL NETWORK B, SOCIAL NETWORK C.” The sending device (210) may display a similar confirmation screen after receiving confirmations of the links having been made on the social networks.

Accordingly, as has been described, links on social networks can be made using information that is communicated between the devices (210 and 212). This may allow links to be made with little user input. For example, the links may be made without a user of either device having to manually enter the username or other contact information for the other user, having to do a search of a social network to locate the other user's profile, etc.

### III. Techniques for Using Devices to Link Social Network Profiles

Several social network profile linking techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable storage media may have computer-executable instructions embodied thereon that, when executed by at least one processor, cause at least one processor to perform the technique.

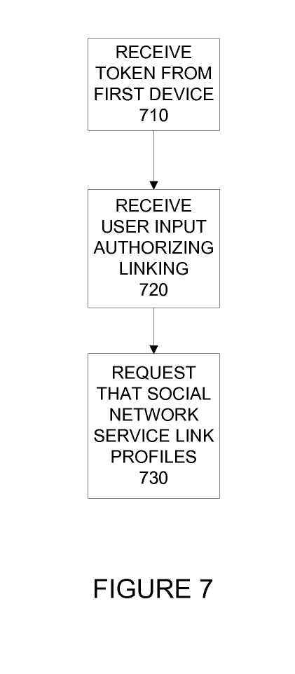

Referring to FIG. 7, a technique for using devices to link social network profiles will be described. The technique can include receiving (710) a token from a first device. The token can be received at a second device, and the token can include information authorizing linking to a first social network profile. Receiving (710) the token can include scanning a tag displayed on a screen of the first device. Alternatively, receiving (710) the token can include receiving a signal from the first device, where the signal encodes the token. For example, the signal may be a wireless signal, such as a signal sent using NFC. An address may also be received from the first device, such as an address for a social network service to link profiles together.

User input can be received (720) at the second device to authorize linking the first social network profile with a second social network profile on a social network. For example, the user input may be a single user input action, such as selecting a button or icon, or some other gesture such as flicking on a touch screen. In response to the user input, a social network service can be requested (730) to link the first social network profile to the second social network profile on the social network. Requesting (730) that the social network service link the first social network profile to the second social network profile can include sending the token from the second device to the social network service in a communication that is associated with the second social network profile. The technique may be performed without requiring more than a single user input action at the second device, or without requiring more than a pair of user input actions at the second device. For example, only a single action may be utilized to confirm authorization to link profiles together. As an example of a pair of actions, a single action may result in scanning a tag or otherwise receiving information from the first device, and a second action may confirm that profiles are to be linked.

The technique may further include sending identifying information for the second social network profile to the social network service. The identifying information may be sent prior to receiving the token from the first device or after receiving the token from the first device.

The token may be included in a communication to the social network. That communication can request that the social network service link the first social network profile to the second social network profile. Also, a confirmation that the first social network profile and the second social network profile have been linked in the social network can be received from the social network service.

An application can be launched on the second device in response to receiving the token. The application can be configured to communicate with the social network service to request that the social network service link profiles together.

For the sake of clarity of the discussion in this paragraph, the social network service of the FIG. 7 technique can be termed a first social network service, the social network can be termed a first social network, and the token can be termed a first token. The technique can further include receiving a second token from the first device. The second token can be received at the second device, and can include information authorizing linking to a third social network profile. The user input can authorize linking the third social network profile with a fourth social network profile on a second social network. In response to the user input, a second social network service can be requested to link the third social network profile to the fourth social network profile on the second social network.

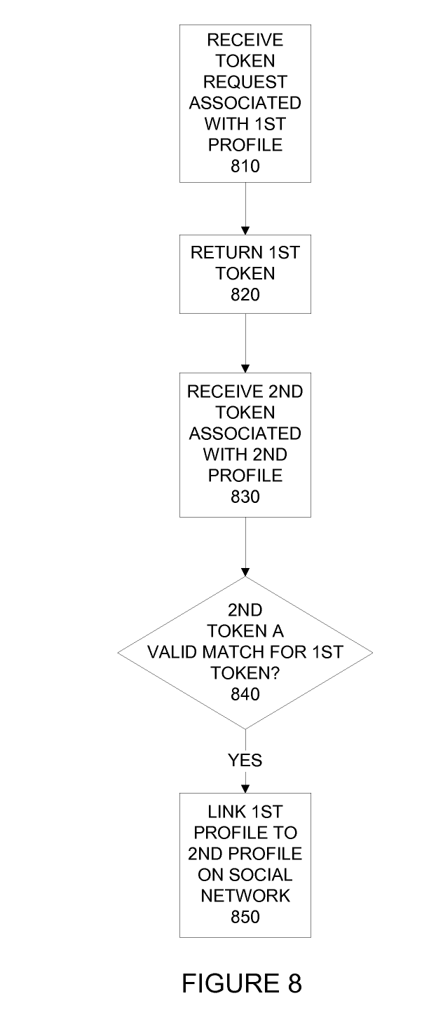

Referring to FIG. 8, another technique for using devices to link social network profiles will be described. The technique can include receiving (810) a token request at a social network service. The token request can be associated with a first profile on the social network. In response to the request, a first token can be returned (820). A second token associated with a second profile on the social network can be received (830). In response to receiving the second token, it can be determined (840) whether the second token is a valid match for the first token, and if so, then the first profile can be linked (850) to the second profile on the social network. The technique may also include generating the first token using a random number generation technique.

Determining (840) whether the second token is a valid match for the first token can include determining whether the second token is the same as the first token. Determining (840) whether the second token is a valid match for the first token may include determining whether a valid time period for the first token has been exceeded.

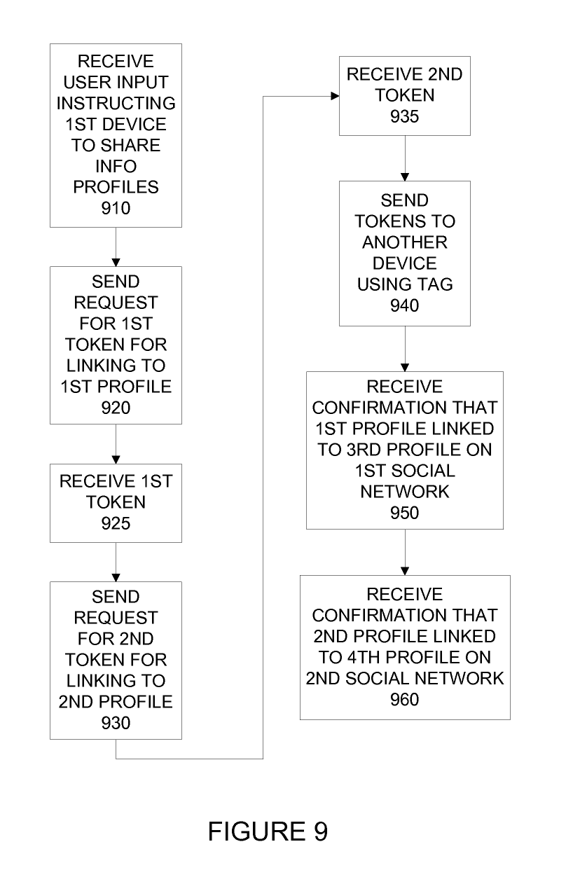

Referring to FIG. 9, yet another technique for using devices to link social network profiles will be described. The technique can include receiving (910) a user input action instructing a first handheld device to share information to link a first social network profile on a first social network and to link a second social network profile on a second social network. A request for a first token for linking the first user profile on the first social network can be sent (920) from the first device to a first social network service. The first token can be received (925) from the first social network service. Additionally, a request for a second token for linking the second social network profile on the second social network can be sent (930) from the first device to a second social network service. The second token (935) can be received from the second social network service.

The first and second tokens can be sent (940) from the first device to a second device. The sending (940) can include displaying a tag on the first device, with the tag encoding the first token and the second token. The technique can also include receiving (950) a confirmation that the first user profile has been linked to a third user profile on the first social network, where the third user profile can be associated with the second device. Additionally, the technique can include receiving (960) a confirmation that the second user profile has been linked to a fourth user profile on the second social network, where the fourth user profile can be associated with the second device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer-implemented method, comprising:
receiving a token from a first device, the token comprising information authorizing linking to a first social network profile, and the token being received at a second device;
receiving user input at the second device to authorize linking the first social network profile with a second social network profile on a social network; and
in response to the user input, requesting that a social network service link the first social network profile to the second social network profile on the social network.

2. The method of claim 1, wherein requesting that the social network service link the first social network profile to the second social network profile comprises sending the token from the second device to the social network service in a communication that is associated with the second social network profile.

3. The method of claim 1, wherein receiving the token from the first device comprises scanning a tag displayed on a screen of the first device.

4. The method of claim 1, wherein receiving the token from the first device comprises receiving a signal from the first device, the signal encoding the token.

5. The method of claim 1, wherein the social network service is a first social network service, the social network is a first social network, the token is a first token, and the method further comprises:
receiving a second token from the first device, the second token comprising information authorizing linking to a third social network profile, and the second token being received at the second device, wherein the user input authorizes linking the third social network profile with a fourth social network profile on a second social network; and
in response to the user input, requesting that a second social network service link the third social network profile to the fourth social network profile on the second social network.

6. The method of claim 5, wherein the user input is a single user input action.

7. The method of claim 1, further comprising sending identifying information for the second social network profile to the social network service.

8. The method of claim 7, wherein the identifying information is sent prior to receiving the token from the first device.

9. The method of claim 7, wherein the identifying information is sent after receiving the token from the first device.

10. The method of claim 1, wherein a communication to the social network service includes the token and wherein the communication to the social network requests that the social network service link the first social network profile to the second social network profile.

11. The method of claim 1, further comprising receiving confirmation from the social network service that the first social network profile and the second social network profile have been linked in the social network.

12. The method of claim 1, further comprising launching an application on the second device in response to receiving the token, the application being configured to communicate with the social network service.

13. The method of claim 1, wherein the method is performed without requiring more than a single user input action at the second device.

14. The method of claim 1, wherein the method is performed without requiring more than a pair of user input actions at the second device.

15. The method of claim 1, further comprising receiving from the first device an address for the social network service.

16. One or more computer-readable storage media having computer-executable instructions embodied thereon that, when executed by at least one processor, cause at least one processor to perform acts comprising:
receiving a token request at a social network service that manages a social network, the token request being associated with a first profile on the social network;
in response to the token request, returning a first token;
receiving a second token associated with a second profile on the social network; and
in response to receiving the second token, performing the following acts:
determining whether the second token is a valid match for the first token; and
if the second token is a valid match for the first token, then linking the first profile to the second profile on the social network.

17. The one or more computer-readable storage media of claim 16, wherein determining whether the second token is a valid match for the first token comprises determining whether the second token is the same as the first token.

18. The one or more computer-readable storage media of claim 16, wherein determining whether the second token is a valid match for the first token comprises determining whether a valid time period for the first token has been exceeded.

19. The one or more computer-readable storage media of claim 16, further comprising generating the first token using a random number generation technique.

20. A computer system comprising:
at least one processor; and
memory comprising instructions stored thereon that when executed by at least one processor cause at least one processor to perform acts comprising:
receiving a user input action instructing a first device to share information to link a first social network profile on a first social network and to link a second social network profile on a second social network;
sending from the first device to a first social network service a request for a first token for linking the first user profile on the first social network;
receiving the first token from the first social network service;
sending from the first device to a second social network service a request for a second token for linking the second social network profile on the second social network;
receiving the second token from the second social network service;
sending the first token and the second token from the first device to a second device, the sending comprising displaying a tag on the first device, the tag encoding the first token and the second token;
receiving a confirmation that the first user profile has been linked to a third user profile on the first social network, the third user profile being associated with the second device; and
receiving a confirmation that the second user profile has been linked to a fourth user profile on the second social network, the fourth user profile being associated with the second device.
